(19) United States
(12) Patent Application Publication
(10) Pub. No.: US 2020/0286182 A1
(43) Pub. Date: Sep. 10, 2020

(54) METHOD FOR ALLOCATING PROCESSING TASK OF INSURANCE SERVICE, STORAGE MEDIUM, TERMINAL DEVICE AND APPARATUS

(71) Applicant: PING AN TECHNOLOGY (SHENZHEN) CO., LTD., Shenzhen, Guangdong (CN)

(72) Inventors: Yunpeng JIANG, Shenzhen (CN); Jie DING, Shenzhen (CN); Jian LING, Shenzhen (CN); Haibo WU, Shenzhen (CN); Xiangdong MA, Shenzhen (CN)

(21) Appl. No.: 16/301,431

(22) PCT Filed: Feb. 13, 2018
(86) PCT No.: PCT/CN2018/076664

§ 371 Date: Nov. 13, 2018

(30) Foreign Application Priority Data
Feb. 16, 2017 (CN) 201710083348.5

(51) Int. Cl. G06Q 40/08; G06Q 40/02; G06Q 40/00; G06Q 10/10; G06Q 10/06

(52) U.S. Cl. CPC G06Q 40/08; G06Q 40/02; G06Q 10/06311; G06Q 10/10; G06Q 40/10

(57) ABSTRACT

The present application discloses a method for allocating processing task of insurance service, a computer readable storage medium, a terminal device and an apparatus. This method comprises: determining a processing task to be allocated and an insurance service corresponding to the processing task; acquiring an evaluation factor of the insurance service; determining a processing authority level required by the processing task according to the acquired evaluation factor; determining institution authority levels of various insurance institutions according to the acquired evaluation factor and preset institution factors of the various insurance institutions; determining a first insurance institution entitled to handle the processing task according to the processing authority level and the institution authority levels; and allocating the processing task to the first insurance institution according to a preset allocation rule.

The present application claims the priority of Chinese patent application as filed on Feb. 16, 2017 with the application number of 201710083348.5 and entitled “a method for allocating processing task of insurance service, storage medium, terminal device and apparatus”, said Chinese patent application is incorporated herein by reference in its entirety.

### TECHNICAL FIELD

The present application pertains to the technical field of financial service, and particularly to a method for allocating processing task of insurance service, a computer readable storage medium, a terminal device and an apparatus.

### BACKGROUND

In the insurance industry, due to the fact that an insurance service often relate to huge insurance premium and insurance amount, regarding processing of the insurance service, such as processing operations including bidding, underwriting, and evaluation, etc., an insurance institution often requires to have a corresponding processing authority. At present, the processing authority required by the insurance service is evaluated by an evaluator generally, and then the processing task of the insurance service is allocated to the corresponding insurance institution according to the manual evaluation result. Therefore, an accuracy of allocation of insurance service is prone to be influenced by practice experience and professional knowledge of the evaluator, and hidden dangers are brought to processing of insurance services; in addition, manually evaluating the processing authority required by the insurance service has a low evaluation efficiency, and increases the cost of processing of insurance service.

### SUMMARY

In a first aspect, embodiments of the present application provide a method for allocating processing task of insurance service, comprising:

determining a processing task to be allocated and an insurance service corresponding to the processing task;

acquiring an evaluation factor of the insurance service;

determining a processing authority level required by the processing task according to the acquired evaluation factor;

determining institution authority levels of various insurance institutions according to the acquired evaluation factor and preset institution factors of the various insurance institutions;

determining a first insurance institution entitled to handle the processing task according to the processing authority level and the institution authority levels; and

allocating the processing task to the first insurance institution according to a preset allocation rule.

In a second aspect, the embodiments of the present application provide a computer readable storage medium which stores a computer readable instruction, wherein the computer readable instruction is executed by a processor, steps in the method for allocating processing task of insurance service proposed in the first aspect of the embodiments of the present application are implemented.

In a third aspect, the embodiments of the present application provide a terminal device comprising a memory, a processor and a computer readable instruction stored in the memory and executable by the processor, wherein when the computer readable instruction is executed by the processor, steps in the method for allocating processing task of insurance service in the first aspect of the embodiments of the present application are implemented.

In a fourth aspect, the embodiments of the present application provide an apparatus for allocating processing task of insurance service comprising:

a task determination module configured to determine a processing task to be allocated and an insurance service corresponding to the processing task;

an evaluation factor acquisition module configured to acquire an evaluation factor of the insurance service;

a processing authority level determination module configured to determine a processing authority level required by the processing task according to the acquired evaluation factor;

an institution authority level determination module configured to determine institution authority levels of various insurance institutions according to the acquired evaluation factor and preset institution factors of the various insurance institutions;

an insurance institution determination module configured to determine a first insurance institution entitled to handle the processing task according to the processing authority level and the institution authority levels; and

a task allocation module configured to allocate the processing task to the first insurance institution according to a preset allocation rule.

In the present application, an automatic determination of processing authority of processing tasks of the insurance service and an automatic allocation of processing tasks are realized, an allocation result is prevented from being affected by practice experience and professional knowledge of an evaluator, an accuracy of allocation of processing task of the insurance service is improved, a risk of processing of the insurance service is reduced; moreover, an evaluation efficiency of the processing authority is improved, and the cost of processing of the insurance service is reduced.

### BRIEF DESCRIPTION OF THE DRAWINGS

FIG. 1 illustrates a flow diagram of a method for allocating processing task of insurance service in a first embodiment of the present application;

FIG. 2 illustrates a flow schematic diagram of a step of determining processing authority level in the method for allocating processing task of insurance service in the present application;

FIG. 3 illustrates a flow schematic diagram of a step of determining an institution authority level in the method for allocating processing task of insurance service in the present application;

FIG. 4 illustrates a flow diagram of a method for allocating processing task of insurance service in a second embodiment of the present application;

FIG. 5 illustrates a structural diagram of an apparatus for allocating processing task of insurance service in an embodiment of the present application.

### EMBODIMENTS OF THE PRESENT APPLICATION

The present application provides a method and an apparatus for allocating processing task of insurance service, which aims at solving a problem that an accuracy of allocation of insurance service in the related art is prone to be influenced by practice experience and professional knowledge of an evaluator, and an evaluation efficiency of processing authority is low.

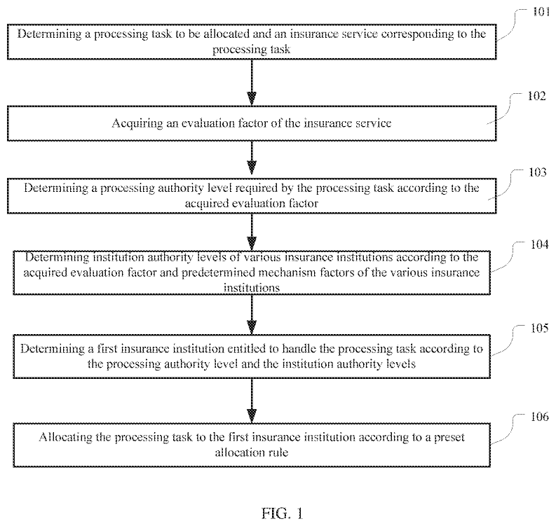

Referring to FIG. 1, a first embodiment of a method for allocating processing task of insurance service comprises:

step 101, determining a processing task to be allocated and an insurance service corresponding to the processing task;

In this embodiment, firstly, the processing task to be allocated and the insurance service corresponding to the processing task can be determined.

It can be understood that, when the insurance service has unallocated processing tasks or processing tasks to be allocated, these processing tasks can be aggregated together and then be allocated centralizedly. Therefore, the processing tasks to be allocated and the insurance services corresponding to the processing tasks can be determined and obtained in a system for centralized allocation of processing tasks.

It should be noted that each insurance service can correspond to a plurality of processing tasks to be allocated according to different requirements.

Step 102, acquiring an evaluation factor of the insurance service;

after the insurance service corresponding to the processing task is determined, an evaluation factor of the insurance service can be obtained.

The aforesaid evaluation factor can include such as a service type, a permission flag, a service attribute, a service intermediary property, a cost rate attribute, an insurance premium and an insurance amount of the insurance service. The permission flag indicates whether the insurance service can be processed by an insurance institution having a corresponding authority; the service attribute includes a master insurance service attribute, and the master insurance service attribute indicates whether the insurance service is a master service; and the service intermediary property represents whether the insurance service is passive or not; the cost rate attribute includes a gross compensation rate, a commission fee rate, a cost rate, a discount, etc.; the insurance premium represents an insurance coverage of the insurance service; and the insurance amount represents the insurance amount of the insurance service.

The aforesaid evaluation factors can be used for evaluating the processing authority levels required by the processing tasks of the insurance service, and can also be used for evaluating the institution authority levels of the corresponding insurance institution, and has huge evaluation value and reference significance in insurance industry. In addition, with the development of insurance service, in order to further improve the evaluation value of these evaluation factors, the contents of the evaluation factors can be increased or modified; for example, the aforesaid insurance premium or insurance amount can be further subdivided, which facilitates an expansion of the insurance service, and improve a flexibility of assessment of the service authority.

Step 103, determining a processing authority level required by the processing task according to the acquired evaluation factor;

The processing authority level required by the processing task can be determined according to the acquired evaluation factor after the evaluation factor of the insurance service is acquired. It can be understood that, from the contents described above, we can get to know that these evaluation factors can be used for evaluating the processing authority level as required by the processing task of the insurance service, thus, the processing authority level required by the processing task can be determined according to these evaluation factors. Generally speaking, in the evaluation factors, the higher the insurance premium, the higher the confirmed processing authority level corresponding to the evaluation factor, otherwise, the lower the insurance premium, the lower the correspondingly confirmed processing authority level; the higher the cost rate, the higher the correspondingly determined processing authority level, otherwise, the lower the cost rate, the lower the correspondingly determined processing authority level, and the like.

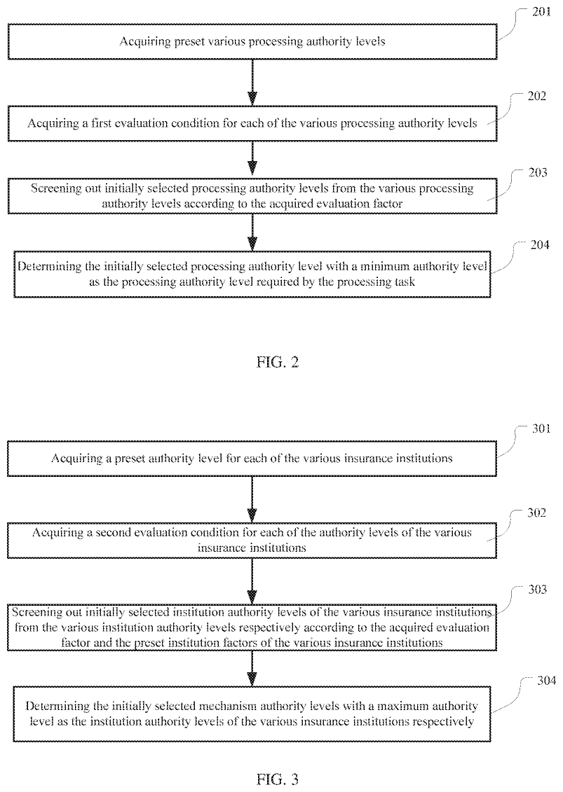

Further, as shown in FIG. 2, said determining processing authority level required by the processing task according to the acquired evaluation factors particularly comprises:

step 201, acquiring preset various processing authority levels;

step 202, acquiring a first evaluation condition for each of the various processing authority levels;

step 203, screening out initially selected processing authority levels from the various processing authority levels according to the acquired evaluation factors, wherein the evaluation factors meet the first evaluation condition corresponding to the initially selected processing authority level;

step 204, determining the initially selected processing authority level with the minimum authority level as the processing authority level as required by the processing task.

Regarding the step 201, each of the processing authority levels can be set in advance, for example, 24 levels can be preset, which can be levels 0-23 respectively, wherein level 0 is the lowest, and level 23 is the highest.

Regarding the step 202, after the various processing authority levels are obtained, first evaluation conditions of the processing authority levels can be obtained. In particular, a corresponding relationship between each of the processing authority levels and each of the first evaluation conditions can be recorded by a processing authority table, one processing authority level may correspond to one first evaluation condition, and may also correspond to a plurality of first evaluation conditions, and it is not limited in this embodiment.

Regarding the step 203, when the acquired evaluation factors meet one of the first evaluation conditions, the processing authority level corresponding to the first evaluation condition can be screened out and taken as the initially selected processing authority level.

For example, assuming that the evaluation factors include the service type, the permission flag, the master service attribute, whether the intermediary is passive, the gross loss ratio, the commission fee rate, the insurance premium, the insurance amount, the cost rate and the discount. The first evaluation condition can be set as judging whether a condition of “the service type is equal to a, the permission flag is equal to b, whether the master service is equal to c, whether the passive intermediary is equal to d, the gross loss ratio is less than or equal to e, the commission fee rate is less than or equal to f, the insurance premium coverage is equal to or more than g, the insurance amount is more than or equal to h; the cost rate is less than or equal to i; the discount is more than or equal to j” is met, that is, judging whether these evaluation factors fall within a corresponding condition range or not. The relationship between the aforesaid a, b, c, d, e, f, g, h, j and the processing authority levels can be expressed by the following table:

| | Processing | | Is there | Whether the | | | | | | |
|---|---|---|---|---|---|---|---|---|---|---|
| Service | authority | Permission | a master | intermediary | Gross loss | Commission | Insurance | Insurance | Cost | |
| type(a) | level(y) | flag(b) | service (c) | is passive (d) | ratio(e) | cost rate(f) | premium(g) | amount (h) | ratio (i) | Discount (j) |
| 1 | 1 | Y | Y | Y | 1 | 0.25 | 500000 | 999999999 | 1 | 0.01 |
| 1 | 13 | Y | Y | Y | 1 | 0.25 | 15000000 | 999999999 | 1 | 0.01 |
| 1 | 12 | Y | Y | Y | 1 | 0.25 | 10000000 | 999999999 | 1 | 0.01 |
| 1 | 2 | Y | Y | Y | 1 | 0.25 | 1000000 | 999999999 | 1 | 0.01 |
| 1 | 21 | Y | Y | Y | 1 | 0.25 | 9999999999 | 999999999 | 1 | 0.01 |
| 2 | 3 | Y | N | Y | 1 | 1 | 1000000 | 999999999 | 0.94 | 0.48 |
| 2 | 2 | Y | N | Y | 1 | 1 | 500000 | 999999999 | 0.94 | 0.6 |
| 2 | 11 | Y | N | Y | 1 | 1 | 1000000 | 999999999 | 0.94 | 0.48 |
| 2 | 22 | Y | Y | Y | 1 | 1 | 1000000 | 999999999 | 0.94 | 0.1 |
| 2 | 23 | Y | Y | Y | 1 | 1 | 9999999999 | 999999999 | 1 | 0.1 |
| . . . | . . . | . . . | . . . | . . . | . . . | . . . | . . . | . . . | . . . | . . . |

Wherein, Y represents that there is an authority, and N represents that there is no authority. The processing authority level can be formulized as y=f (a, b, c, d, e, f, g, h, i, j).

For the aforesaid step 204, after the initially selected processing authority level is screened out, the initially selected processing authority level with the minimum authority level can be determined as the processing authority level required by the processing task. It can be understood that, as for the processing task, when there are a plurality of selectable processing authority levels of the processing task, at this time, in order to facilitate processing of the processing task by the insurance institution and improve the processing efficiency, a processing authority level with the minimum processing authority level should be selected from the plurality of selectable processing authority levels. The finally determined required processing authority level is formulized as y=min(f (a, b, c, d, e, f, g, h, i, j)).

Step 104, determining institution authority levels of the various insurance institutions according to the acquired evaluation factors and the preset institution factors of the various insurance institutions.

After obtaining the evaluation factors, the institution authority levels of the various insurance institutions can be determined according to the required evaluation factors and the preset institution factors of the various insurance institutions. It can be understood that, from the contents described above, we can get to know that these evaluation factors can be used for evaluating the institution authority levels of the corresponding insurance institutions. In addition, in order to increase a correlation between the institution authority levels and the various insurance institutions, institution factors of the various insurance institutions are added simultaneously and serve as reference factors for evaluation, so that the institution authority levels of the insurance institutions can be determined according to the evaluation factors and the institution factors. The aforesaid institution factors can include an institution type and a permission flag of the insurance institution, wherein, a correlation between the institution type and the institution authority level can be set in advance, and the permission flag of the insurance institution indicates whether the insurance institution can have a corresponding authority of the processing task.

Further, as shown in FIG. 3, said determining the institution authority levels of the various insurance institutions according to the acquired evaluation factors and the preset institution factors of the various insurance institutions can comprise:

301, acquiring preset various institution authority levels;

302, acquiring a second evaluation condition each of the various institution authority levels;

303, screening out the initially selected institution authority levels of the various insurance institutions from the various institution authority levels respectively according to the acquired evaluation factors and the preset institution factors of the various insurance institutions, wherein the evaluation factors and the institution factors meet the second evaluation condition corresponding to the initially selected institution authority level;

304, determining the initially selected institution authority levels with the maximum authority level as the institution authority levels of the various insurance institutions.

Regarding the step 301, each of the processing authority levels can be set in advance, for example, 24 levels can be preset, which can be levels 0-23 respectively, wherein level 0 is the lowest, and level 23 is the highest.

Regarding the step 302, after the various processing authority levels are obtained, the first evaluation conditions of the processing authority levels can be obtained. In particular, a corresponding relationship between each of the processing authority levels and each second evaluation condition can be recorded by a processing authority table, one processing authority level may correspond to one second evaluation condition, and may also correspond to a plurality of second evaluation conditions, and it is not limited in this embodiment.

Regarding the step 303, when the acquired evaluation factors meet one of second evaluation conditions, the processing authority level corresponding to the second evaluation condition can be screened out and taken as the initially selected processing authority level.

For example, assuming that the evaluation factors include the service type (for evaluating an institution authority level of an insurance institution, the evaluation factors of the service type can be considered to have enough reference value), the institution factors include an institution type and a permission flag of the insurance institution. Then, the second evaluation condition can be set to be judging whether a condition of “the service type is equal to q, the institution type is equal to p, the permission flag is equal to r” is met, that is, judging whether the evaluation factors and the institution factors fall within the corresponding condition ranges. The relation between the aforesaid q, p, r and the institution authority levels can be represented by the following table:

| | | | Institution |
|---|---|---|---|
| Institution | Service | Permission | authority |
| type(p) | type(q) | flag(r) | level (z) |
| G01 | 4 | Y | 13 |
| G01 | 2 | Y | 13 |
| G01 | 8 | N | 13 |
| G01 | 14 | N | 13 |
| G01 | 13 | N | 13 |
| G02 | 4 | Y | 13 |
| G02 | 2 | Y | 13 |
| G02 | 11 | Y | 13 |
| G02 | 14 | N | 13 |
| G02 | 8 | N | 13 |
| . . . | . . . | . . . | . . . |

Wherein, Y represents that there is an authority, and N represents that there is no authority. The institution authority level can be formulized as z=g (p, q, r).

Regarding the aforesaid step 303, it needs to be explained that, there may be one, two or more than two initially selected institution authority levels acquired finally by one insurance institution, at this time, the institution authority level of each insurance institution needs to be determined finally by executing step 304.

Regarding the aforesaid step 304, after the initially selected processing authority level is screened out, the initially selected processing authority levels with the maximum authority level can be determined as the processing authority levels required by the various insurance institutions. It can be understood that, when there are a plurality of initially selected institution authority levels corresponding to the one insurance institution, at this time, in order to facilitate processing of the processing task by the insurance institution and improve the processing efficiency, each of the various insurance institutions should be provided with a processing authority level with the maximum authority level in a reasonable range. The finally determined institution authority levels of the various insurance institutions are formulized as z=max (g (p, q, r)).

For example, assuming that in the obtained initially selected institution authorities, the initially selected institution processing authority corresponding to the insurance institution G01 is 13, 5 and 8, the initially selected institution processing authority corresponding to the insurance institution G02 is 13, 20 and 3, then, the institution processing authority of the insurance institution G01 is finally determined to be 13, and the institution processing authority of the insurance institution G02 is finally determined to be 20.

Step 105, determining a first insurance institution entitled to handle the processing task according to the processing authority level and the institution authority level.

After determining the processing authority level and the institution authority level, the first insurance institution entitled to handle the processing tasks can be determined according to the processing authority level and the institution authority level.

Preferably, the insurance institution which has the institution authority level larger than or equal to the processing authority level can be determined as the first insurance institution. It can be understood that, since the processing task needs to be allocated to the insurance institution to be processed, the institution authority level of the insurance institution entitled to handle the processing tasks should be larger than the processing authority level of the processing task, thereby facilitating a risk control.

Step 106, distributing the processing tasks to the first insurance institution according to a preset allocation rule.

After the first insurance institution entitled to handle the processing tasks is determined, the processing tasks can be allocated to the first insurance institution according to the preset allocation rule. It can be understood that, since one processing task is generally allocated to one first insurance institution, thus, the processing tasks can be allocated to the first insurance institutions according to preset allocation rule.

It should be explained that, for a special processing task, the special processing task can also be processed by a plurality of first insurance institutions cooperatively.

In this embodiment, an automatic determination of processing authority of processing task of the insurance service and an automatic allocation of processing task are realized, an allocation result can be prevented from being influenced by practice experience and professional knowledge of the evaluator, an accuracy of allocation of processing task of the insurance service is improved, a processing risk of the insurance service is reduced; moreover, an evaluation efficiency of the processing authority is improved, and the cost of processing of the insurance service is reduced.

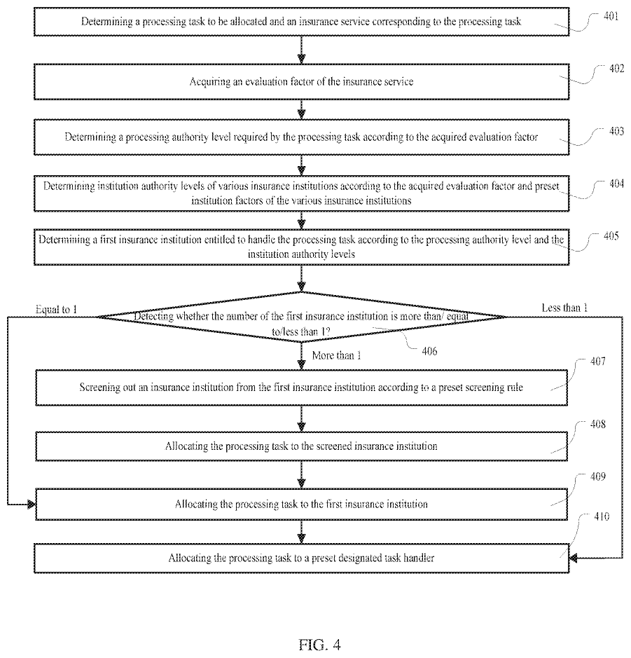

Referring to FIG. 4, a second embodiment of a method for allocating processing task of insurance service in the present application comprises:

step 401, determining a processing task to be distributed and an insurance service corresponding to the processing task;

step 402, acquiring an evaluation factor of the insurance service;

step 403, determining a processing authority level required by the processing task according to the acquired evaluation factor;

step 404, determining institution authority levels of the various insurance institutions according to the acquired evaluation factor and the preset institution factors of the various insurance institutions;

step 405, determining a first insurance institution entitled to handle the processing task according to the processing authority level and the institution authority level;

steps 401-405 are as same as steps 101-105, regarding the detail of steps 401-405, references can be made to relevant descriptions of steps 101-105.

Step 406, judging whether the number of the first insurance institution is larger than, equal to or less than 1;

step 407, screening out an insurance institution from the first insurance institutions according to a preset screening rule if the number of the first insurance institutions is larger than 1;

If the number of the first insurance institution is larger than 1, an insurance institution can be screened out from the first insurance institution according to the preset screening rule. It can be understood that since one processing task is generally allocated to one first insurance institution, when the number of the first insurance institution is larger than 1, an insurance institution can be screened out from the first insurance institution according to the preset screening rule.

The aforesaid screening rule can be selecting the first insurance institution which has a closest distance according to geographic positions related to the processing task, so that it is convenient for the first insurance institution to process the processing task, and a reduction of cost spent on the processing task can be facilitated; as an alternative, the aforesaid screening rule can be selecting the insurance institution with the maximum authority level from the first insurance institution.

Step 408, allocating the processing task to the screened insurance institution;

after one insurance institution is screened out, the processing task can be allocated to the screened insurance institution.

Step 409, allocating the processing task to the first insurance institution;

if the number of the first insurance institution is equal to 1, the processing task can be allocated to the first insurance institution. It can be understood that, when there is only one first insurance institution, the processing task can be directly allocated to the first insurance institution.

Step 410, allocating the processing task to a preset designated task handler if the number of the first insurance institution is less than 1.

If the number of the first insurance institution is less than 1, the processing task can be allocated to the preset designated task handler.

Further, the designated task handler can be special processing personnel. Said allocating the processing task to the preset designated task handler can particularly comprise: acquiring personnel authority levels of the various special processing personnel, and allocating the processing task to the special processing personnel with the personnel authority level larger than or equal to the processing authority level.

Particularly, said allocating the processing task to the preset designated task handler can be as follows: firstly, special processing personnel is obtained, and the personnel authority level of the special processing personnel is obtained, and whether the authority level of the special processing personnel is larger than or equal to the processing authority level is judged; if the authority level of the special processing personnel is larger than or equal to the processing authority level, the processing task is allocated to the special processing personnel; otherwise, a next special processing personnel is obtained continuously until the processing task is allocated or a judgment of authority level has been performed for all special processing personnel. It should be noted that these special processing personnel can belong to various insurance institutions. In this embodiment, when the number of the first insurance institution is 0 (the number is less than 1 means that the number is 0), it means that there is no insurance institution that meets the condition, however, the special processing personnel in these insurance institutions may have the personnel authority level that is larger than the processing authority level.

Furthermore, in this embodiment, the designated task handler can also be a headquarter of an insurance institution. Said allocating the processing task to the preset designated task handler can be: when the personnel authority levels of all special processing personnel are smaller than the processing authority level, the processing task can be allocated to the headquarter of the insurance institution to be processed finally.

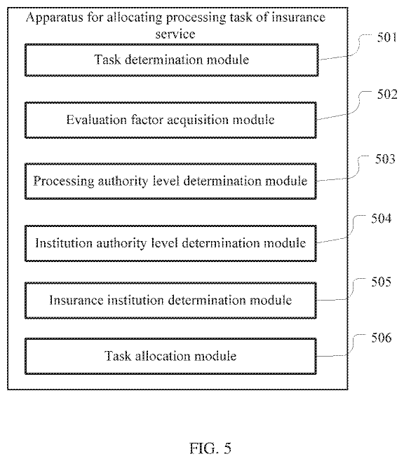

FIG. 5 illustrates a structural block diagram of an apparatus for allocating processing task of insurance service in the present application.

In this embodiment, an apparatus for allocating processing task of insurance service comprises:

a task determination module 501 configured to determine a processing task to be allocated and an insurance service corresponding to the processing task;

an evaluation factor acquisition module 502 configured to acquire an evaluation factor of the insurance service;

a processing authority level determination module 503 configured to determine a processing authority level required by the processing task according to the acquired evaluation factor;

an institution authority level determination module 504 configured to determine institution authority levels of various insurance institutions according to the acquired evaluation factor and preset institution factors of the various insurance institutions;

an insurance institution determination module 505 configured to determine a first insurance institution entitled to handle the processing task according to the processing authority level and the institution authority levels; and

a task allocation module 506 configured to allocate the processing task to the first insurance institution according to a preset allocation rule.

Further, the processing authority level determination module 503 particularly comprises:

a processing authority level acquisition unit configured to acquire the various processing authority levels;

a first evaluation condition acquisition unit configured to acquire a first evaluation condition of each of the various processing authority levels;

a first screening unit configured to screen out initially selected processing authority levels from the various processing authority levels according to the acquired evaluation factor; wherein the evaluation factor meets the first evaluation condition corresponding to the initially selected processing authority level; and

a first determination unit configured to determine the initially selected processing authority level with a minimum authority level as the processing authority level required by the processing task.

Furthermore, the institution authority level determination module particularly comprises:

an institution authority level acquisition unit configured to acquire preset various institution authority levels;

a second evaluation condition acquisition unit configured to acquire a second evaluation condition of each of the various institution authority levels;

a second screening unit configured to screen out initially selected institution authority levels of the various insurance institutions from the various institution authority levels respectively according to the acquired evaluation factor and the preset institution factors of the various insurance institutions; wherein the evaluation factor and the institution factors meet the second evaluation condition corresponding to the initially selected institution authority level; and

a second determination unit configured to determine the initially selected institution authority levels with a maximum authority level as the institution authority levels of the various insurance institutions respectively.

Furthermore, the task allocation module particularly comprises:

a first allocation unit configured to screen out an insurance institution from the first insurance institution according to a preset screening rule and then allocate the processing task to the screened insurance institution, if the number of the first insurance institutions is larger than 1;

a second allocation unit configured to allocate the processing task to the first insurance institution, if the number of the first insurance institution is equal to 1; and

a third allocation unit configured to allocate the processing task to a preset designated task handler, if the number of the first insurance institution is less than 1.

Furthermore, the designated task handler can be special handling personnel;

the third allocation unit can comprise:

a personal authority level acquisition sub-unit configured to acquire a personnel authority level for each of the special handling personnels; and

a task allocation sub-unit configured to allocate the processing task to the special handling personnel with the personnel authority level larger than or equal to the processing authority level.

Embodiments of the present application further provides a computer readable storage medium which stores a computer readable instruction, when the computer readable instruction is executed by a processor, steps in the method for allocating processing task of insurance service as represented by any one of FIGS. 1-4 are implemented.

Embodiments of the present application further provide a terminal device which comprises a memory, a processor and a computer readable instruction stored in the memory and executable by the processor, when the processor executes the computer readable instruction, steps in the method for allocating processing task of insurance service as represented in any one of FIGS. 1-4 are implemented.

1. A method for allocating processing task of insurance service, comprising:
determining a processing task to be allocated and an insurance service corresponding to the processing task;
acquiring an evaluation factor of the insurance service;
determining a processing authority level required by the processing task according to the acquired evaluation factor;
determining institution authority levels of various insurance institutions according to the acquired evaluation factor and preset institution factors of the various insurance institutions;
determining a first insurance institution entitled to handle the processing task according to the processing authority level and the institution authority levels; and
allocating the processing task to the first insurance institution according to a preset allocation rule.

2. The method for allocating processing task according to claim 1, wherein the step of determining a processing authority level required by the processing task according to the acquired evaluation factor particularly comprises:
acquiring preset various processing authority levels;
acquiring a first evaluation condition for each of the various processing authority levels;
screening out initially selected processing authority levels from the various processing authority levels according to the acquired evaluation factor; wherein the evaluation factor meets the first evaluation condition corresponding to the initially selected processing authority level; and
determining the initially selected processing authority level with a minimum authority level as the processing authority level required by the processing task.

3. The method for allocating processing task according to claim 1, wherein the step of determining institution authority levels of various insurance institutions according to the acquired evaluation factor and preset institution factors of the various insurance institutions particularly comprises:
acquiring preset various institution authority levels;
acquiring a second evaluation condition for each of the various institution authority levels;
screening out initially selected institution authority levels of the various insurance institutions from the various institution authority levels respectively according to the acquired evaluation factor and the preset institution factors of the various insurance institutions; wherein the evaluation factor and the institution factors meet the second evaluation condition corresponding to the initially selected institution authority level; and
determining the initially selected institution authority levels with a maximum authority level as the institution authority levels of the various insurance institutions, respectively.

4. The method for allocating processing task according to claim 1, wherein the step of allocating the processing task to the first insurance institution according to a preset allocation rule particularly comprises:
screening out an insurance institution from the first insurance institutions according to a preset screening rule and then allocating the processing task to the screened insurance institution, if the number of the first insurance institutions is larger than 1;
allocating the processing task to the first insurance institution, if the number of the first insurance institution is equal to 1;
allocating the processing task to a preset designated task handler, if the number of the first insurance institution is less than 1.

5. The method for allocating processing task according to claim 4, wherein the designated task handler is a special handling personnel;
the step of allocating the processing task to a preset designated task handler particularly comprises:
acquiring a personnel authority level for each of the special handling personnel; and
allocating the processing task to a special handling personnel with the personnel authority level larger than or equal to the processing authority level.

6. A computer readable storage medium which stores a computer readable instruction, wherein when executing the computer readable instruction, a processor implements the steps of:
determining a processing task to be allocated and an insurance service corresponding to the processing task;
acquiring an evaluation factor of the insurance service;
determining a processing authority level required by the processing task according to the acquired evaluation factor;
determining institution authority levels of various insurance institutions according to the acquired evaluation factor and preset institution factors of the various insurance institutions;
determining a first insurance institution entitled to handle the processing task according to the processing authority level and the institution authority levels; and
allocating the processing task to the first insurance institution according to a preset allocation rule.

7. The computer readable storage medium according to claim 6, wherein the step of determining a processing authority level required by the processing task according to the acquired evaluation factor particularly comprises:
acquiring preset various processing authority levels;
acquiring a first evaluation condition for each of the various processing authority levels;
screening out initially selected processing authority levels from the various processing authority levels according to the acquired evaluation factor; wherein the evaluation factor meets the first evaluation condition corresponding to the initially selected processing authority level; and
determining the initially selected processing authority level with a minimum authority level as the processing authority level required by the processing task.

8. The computer readable storage medium according to claim 6, wherein the step of determining institution authority levels of various insurance institutions according to the acquired evaluation factor and preset institution factors of the various insurance institutions particularly comprises:
acquiring preset various institution authority levels;
acquiring a second evaluation condition for each of the various institution authority levels;
screening out initially selected institution authority levels of the various insurance institutions from the various institution authority levels respectively according to the acquired evaluation factor and the preset institution factors of the various insurance institutions; wherein the evaluation factor and the institution factors meet the second evaluation condition corresponding to the initially selected institution authority level; and
determining the initially selected institution authority levels with a maximum authority level as the institution authority levels of the various insurance institutions respectively.

9. The computer readable storage medium according to claim 6, wherein the step of allocating the processing task to the first insurance institution according to a preset allocation rule particularly comprises:
screening out an insurance institution from the first insurance institutions according to a preset screening rule and then allocating the processing task to the screened insurance institution, if the number of the first insurance institutions is larger than 1;
allocating the processing task to the first insurance institution, if the number of the first insurance institution is equal to 1;
allocating the processing task to a preset designated task handler, if the number of the first insurance institution is less than 1.

10. The computer readable storage medium according to claim 9, wherein the designated task handler is a special handling personnel;
the step of allocating the processing task to a preset designated task handler particularly comprises:
acquiring a personnel authority level for each of the special handling personnel; and
allocating the processing task to a special handling personnel with the personnel authority level larger than or equal to the processing authority level.

11. A terminal device comprising a memory, a processor and a computer readable instruction stored in the memory and executable by the processor, wherein when executing the computer readable instruction, the processor implements following steps of:
determining a processing task to be allocated and an insurance service corresponding to the processing task;
acquiring an evaluation factor of the insurance service;
determining a processing authority level required by the processing task according to the acquired evaluation factor;
determining institution authority levels of various insurance institutions according to the acquired evaluation factor and preset institution factors of the various insurance institutions;
determining a first insurance institution entitled to handle the processing task according to the processing authority level and the institution authority levels; and
allocating the processing task to the first insurance institution according to a preset allocation rule.

12. The terminal device according to claim 1, wherein the step of determining a processing authority level required by the processing task according to the acquired evaluation factor particularly comprises:
acquiring preset various processing authority levels;
acquiring a first evaluation condition for each of the various processing authority levels;
screening out initially selected processing authority levels from the various processing authority levels according to the acquired evaluation factor; wherein the evaluation factor meets the first evaluation condition corresponding to the initially selected processing authority level; and
determining the initially selected processing authority level with a minimum authority level as the processing authority level required by the processing task.

13. The terminal device according to claim 11, wherein the step of determining institution authority levels of various insurance institutions according to the acquired evaluation factor and preset institution factors of the various insurance institutions particularly comprises:
acquiring preset various institution authority levels;
acquiring a second evaluation condition for each of the various institution authority levels;
screening out initially selected institution authority levels of the various insurance institutions from the various institution authority levels respectively according to the acquired evaluation factor and the preset institution factors of the various insurance institutions; wherein the evaluation factor and the institution factors meet the second evaluation condition corresponding to the initially selected institution authority level; and
determining the initially selected institution authority levels with a maximum authority level as the institution authority levels of the various insurance institutions, respectively.

14. The terminal device according to claim 11, wherein the step of allocating the processing task to the first insurance institution according to a preset allocation rule particularly comprises:
screening out an insurance institution from the first insurance institutions according to a preset screening rule and then allocating the processing task to the screened insurance institution, if the number of the first insurance institutions is larger than 1;
allocating the processing task to the first insurance institution, if the number of the first insurance institution is equal to 1;
allocating the processing task to a preset designated task handler, if the number of the first insurance institution is less than 1.

15. The terminal device according to claim 14, wherein the designated task handler is a special handling personnel;
the step of allocating the processing task to a preset designated task handler particularly comprises:
acquiring a personnel authority level for each of the special handling personnel; and
allocating the processing task to a special handling personnel with the personnel authority level larger than or equal to the processing authority level.

16-20. (canceled)
